(19) United States
(12) Patent Application Publication
(10) Pub. No.: US 2019/0303088 A1
(43) Pub. Date: Oct. 3, 2019

(54) TRANSFERRING AN APPLICATION INTERFACE FROM ONE DEVICE TO ANOTHER DEVICE

(71) Applicant: Alibaba Group Holding Limited, George Town (KY)

(72) Inventor: Zhijun Yuan, Hangzhou (CN)

(21) Appl. No.: 16/379,686

(22) Filed: Apr. 9, 2019

Related U.S. Application Data
(63) Continuation-in-part of application No. PCT/CN2017/104167, filed on Sep. 29, 2017.

(30) Foreign Application Priority Data
Oct. 13, 2016 (CN) 201610896705.5

(51) Int. Cl. G06F 3/14; H04L 29/12; G06F 3/16; G06F 3/0488; G06F 3/01; G06F 3/0482; G06F 9/451

(52) U.S. Cl. CPC G06F 3/1454; H04L 61/2007; G06F 3/167; G06F 9/451; G06F 3/017; G06F 3/0482; G06F 3/0488

(57) ABSTRACT

Transferring an application interface from one device to another device is disclosed, including: presenting, at a first device, a first interface associated with an application; determining interface data comprising a current run status associated with the first interface; and sending the interface data to the second device, wherein the second device is configured to generate a second interface associated with the application based at least in part on the interface data and display the second interface associated with the application. Transferring an application interface from one device to another device further includes: receiving, from a sender device, interface data corresponding to a first interface associated with an application executing at the sender device; parsing the interface data to generate a second interface associated with the application that is determined based on the current run status associated with the first interface associated with the application; and presenting the second interface.

### CROSS REFERENCE TO OTHER APPLICATIONS

This application is a continuation-in-part of and claims priority to International (PCT) Application No. PCT/CN2017/0104167 entitled INTERFACE MOVING METHOD, DEVICE, INTELLIGENT TERMINAL, SERVER AND OPERATING SYSTEM filed on Sep. 29, 2017 which is incorporated herein by reference in its entirety for all purposes, which claims priority to China Patent Application No. 201610896705.5, entitled METHOD, MEANS, SMART TERMINAL, SERVER AND OPERATING SYSTEM FOR INTERFACE TRANSFER, filed on Oct. 13, 2016 which is incorporated by reference in its entirety for all purposes.

### FIELD OF THE INVENTION

The present application relates to a field of terminal technology. In particular, the present application relates to techniques related to transferring an application interface from one device to another device.

### BACKGROUND OF THE INVENTION

As terminal technology develops, more and more users make use of terminals and the terminals are capable of providing an ever-increasing array of functional services. The services currently provided by terminals generally are provided through applications. The portals for providing service functions are generally set up on desktops.

A user may install the same application on various devices and use the applications to perform services/functions that are provided by the applications. For example, the different instances of a same positioning application are respectively installed on a smart phone, a smart watch, and a vehicle-mounted device. Thus, all the devices may use their respective instance of the positioning application for positioning and navigation. Applications may be displayed differently on different devices for various reasons such as device type and screen size, for instance. For example, the display screen of a smart phone may display the entire navigation route, yet the display screen of a smart watch may only display part of the navigation route.

A user may have the same application on different devices and may synchronize the information of different apps by logging into the same user account at the instance of the application at each corresponding device. However, conventionally, such an approach can only synchronize some historical records, photographs, contacts, and other such information of the user but cannot synchronize the user's current operation of one instance of the application. For example, if the user is currently using the positioning application at a first device but needs to switch to using a second device with its corresponding instance of the positioning application, the user would need to manually input the destination and other information into the application at the second device to resume the navigation that had been previously presented to the user at the first device.

### SUMMARY OF THE INVENTION

The present application discloses techniques comprising:

presenting a first interface associated with an application;

determining interface data comprising a current run status associated with the first interface associated with the application, wherein the interface data is to be sent to a second device; and

sending the interface data to the second device, wherein the second device is configured to generate a second interface associated with the application based at least in part on the interface data, wherein the second device is configured to display the second interface associated with the application.

The present application further discloses techniques comprising:

receiving, from a first device, interface data corresponding to a first interface associated with an application executing at the first device, wherein the interface data comprises a current run status associated with the first interface;

parsing the interface data to generate a second interface associated with the application that is determined based at least in part on the current run status associated with the first interface associated with the application; and

presenting the second interface associated with the application.

### BRIEF DESCRIPTION OF THE DRAWINGS

Various embodiments of the invention are disclosed in the following detailed description and the accompanying drawings.

FIG. 1 is a diagram showing an embodiment of a system for transferring a current run status of an application interface from one device to another device.

FIG. 2 is a diagram showing an example of transferring a current run status of an application interface from one device to two other devices.

FIG. 3 is a flow diagram showing an embodiment of a process for transferring a current run status of an application interface from one device to another device.

FIG. 4 is a sequence diagram showing an example of transferring a current run status of an application interface from one device to another device.

FIG. 5 is a diagram that shows an example second parsing engine that is used to map UI elements of interface data to the UI in an Android positioning and navigation application interface.

FIG. 6 is a flow diagram showing an embodiment of a process for transferring a current run status of an application interface from a first device.

FIG. 7 is a flow diagram showing an embodiment of a process for receiving a transfer of a current run status of an application interface at a second device.

FIG. 8 is a diagram showing an embodiment of a system for transferring a current run status of an application interface between a first device and a second device.

FIG. 9 is a diagram showing an embodiment of a first device for transferring a current run status of an application interface to a second device.

FIG. 10 is a diagram showing an embodiment of a second device for receiving a transfer of a current run status of an application interface from a first device.

FIG. 11 is a hardware structural diagram of a terminal that is configured to transfer an application interface from a first device to a second device.

FIG. 12 is a hardware structural diagram of a terminal device provided by another embodiment of the present application.

FIG. 13A is a diagram showing an embodiment of an operating system of a first device.

FIG. 13B is a diagram showing an embodiment of an operating system of a second device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

In various embodiments, “smart terminals” or just “terminals” refer to devices with multimedia functions and the capacity to send and receive data over a network. For example, smart terminals may support audio, video, data, and other functions. In various embodiments, a smart terminal may include a touchscreen and may be a smart phone, a tablet computer, a smart wearable device, a smart TV, or a personal computer. In various embodiments, a smart terminal may use various kinds of smart operating systems, such as IOS, Android, and YunOS, for example.

When a user switches between using an application at a first device to using another instance of the same application at a second device (e.g., by signing into the same user account with the application at both devices), the historical data associated with the user account with the application is synchronized between the devices. However, conventionally, the current information that is being used or processed by the application at one device is typically not synchronized with another instance of the same application at another device. Moreover, having the user manually start the application at the second device and/or manually reenter input data or search for an interface in an application executing at a device is inefficient and inconvenient.

Embodiments of transferring a current run status of an application interface from one device to another device are described herein. A first interface associated with an application is presented at a first device. Interface data comprising a current run status associated with the first interface associated with the application is determined. The interface data is sent to a second device. The second device is configured to generate a second interface associated with the application based at least in part on the interface data. The second device is configured to display the second interface associated with the application.

Therefore, various embodiments described herein provide techniques associated with transferring the current state of an application's interface from one device to another device. Therefore, when a user who is using one instance of an application executing at a first device needs to switch to using a second instance of the application executing at a second device, the current state of the interface of the application at the first device can be transferred to the same application executing at the second device. This transfer of interface state information enables a user to seamlessly transition from one device to another without losing the context that was associated with the application's execution at the first device.

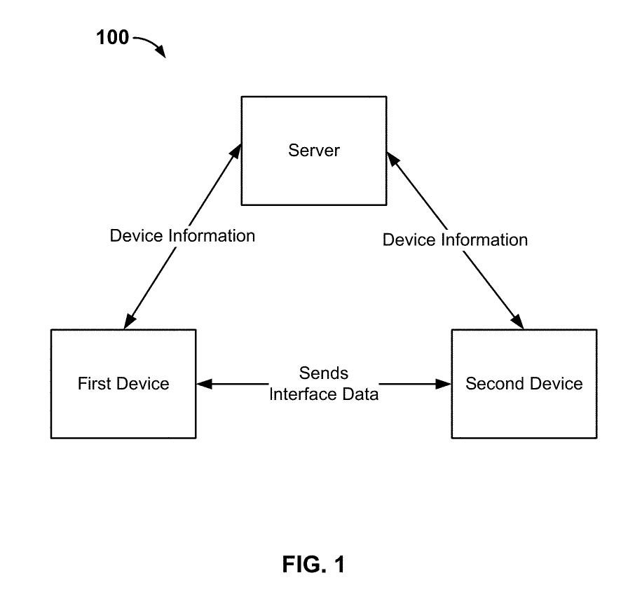

FIG. 1 is a diagram showing an embodiment of a system for transferring a current run status of an application interface from one device to another device.

System 100 includes a server, a first device, and a second device. In various embodiments, a “device” is referred to as a “terminal.” The server of system 100 comprises a service platform that is capable of providing transfers of the current run status of an application interface. The server may be implemented as one or more servers. In various embodiments, the server may collect device information from various devices and may also provide device information to devices that query for device information. In various embodiments, a “client” is software that is capable of supporting the transfer of the current run status of an application's interface from one device to another device. The client may run on a smart terminal. For example, a client corresponds to an application executing on a smart terminal. Clients may be developed by third party service providers, such as independent software vendors (ISV). Applications and/or ISVs provide the interface data that is used to transfer the current run status of its interface. Applications enable the current run statuses of their interfaces to be transferred between different devices.

In various embodiments, the original, pre-transfer interface that is presented on a smart terminal is sometimes referred to as the “first interface,” and the smart terminal that displays the first interface is sometimes referred to as the “first device” or the “sender device.” In various embodiments, the interface that is presented on the second smart terminal after being transferred to the second smart terminal is sometimes referred to as the “second interface.” In various embodiments, the smart terminal to which the interface is transferred is called the “second device” or the “recipient device.” In various embodiments, the transfer function-supporting interface is developed by a third party service provider, which may develop a corresponding interface based on its own features so as to provide the user with corresponding service features. Once the third party service provider completes development of a transfer function-supporting interface, which in various embodiments is sometimes referred to as the “interface data,” it may upload the interface data to a server. After the server receives the transfer function-supporting interface, it may make a record (e.g., store or cache a copy) of the interface and store information associated with the interface. For example, the server may store the software interface publisher, the features that are provided by the interface, and supported device information for each of the corresponding interface data. In some embodiments, the server may publish information associated with each transfer function-supporting interface at a service platform (e.g., a website or other portal).

An application running on the first device displays a first interface. While the first interface is shown at the first device, the user of the first device may use a corresponding service feature that is provided by the first interface. In a first example, if the application is a movie ticket purchasing application, then the user can purchase a movie ticket from the application. In a second example, if the application were a messaging application, the user may be messaging with one or more other users. In a third example, if the application were a social networking application, then the user may be engaging with social networking posts. In a fourth example, if the application were a positioning and navigation application, then the user may be seeking directions to a destination location. If, while using a service feature on the first interface, a user needs to switch to using a second device (e.g., because the user needs to leave the physical location at which the first device is located), the user may trigger interface transfer of the first interface through one of a set of preset input modes such as voice activation by speaking a keyword or phrase, tapping an interactive element, or performing a gesture with respect to the first device. In response to the user triggered interface transfer, identifying information associated with one or more other devices to which the current run status of the first interface can be transferred may be presented at the first interface at the first device. The user may then select one of such devices for which identifying information is presented. The to-be-transferred interface data corresponding to the first interface is determined at the first device based at least in part on the current run status of the first interface. In various embodiments, the “current run status” refers to data that is needed to recreate the content of the first interface of the application or to resume from the point that data had been processed by the first interface of the application. In various embodiments, identifying information associated with the other devices to which the first interface may be transferred is received from the server. The first device then sends the interface data to the second device. After receiving the interface data, the second device may parse the received interface data and then use the parsed data to generate a corresponding second interface. Thus, the second interface is an interface with content corresponding to the first interface but is adapted to the attributes (e.g., operating system requirements and dimensions and resolution of the display screen) of the second device. As a result, the content that is displayed at the second interface is substantially the same as that of the first interface and therefore, a user is able to seamlessly resume interacting with the second interface as he or she had been using the first interface, without needing to activate/open or input values into the application executing at the second device.

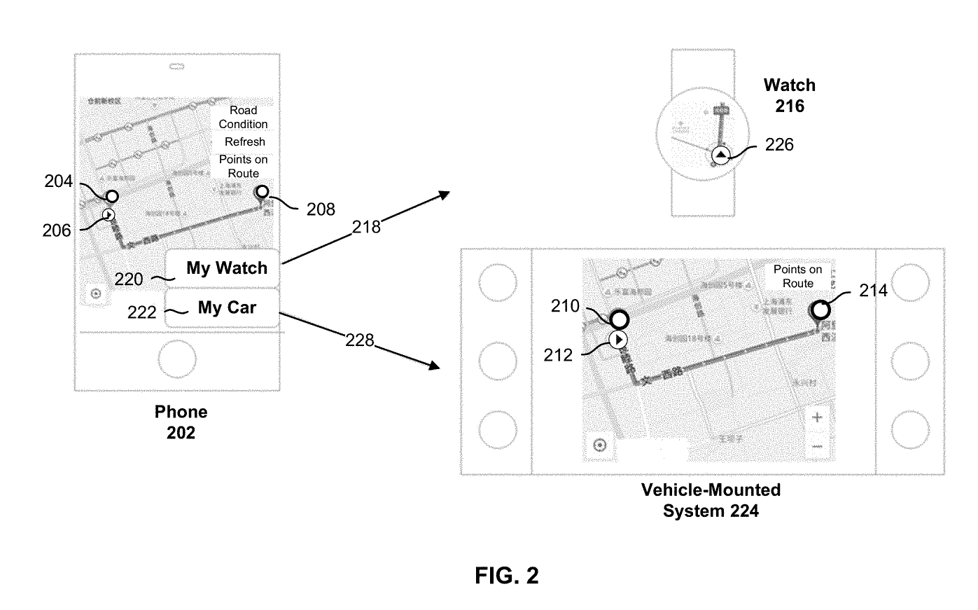

FIG. 2 is a diagram showing an example of transferring a current run status of an application interface from one device to two other devices.

The example of FIG. 2 will illustrate how the current run status of an interface associated with a positioning and navigation application can be transferred from a first device, phone 202, to each of two other devices, watch 216 and vehicle-mounted system 224, in accordance with some embodiments.

Phone 202 is a smart phone that presents, at its display screen, the first interface of a positioning and navigation application. The first interface of the display screen of phone 202 shows an ongoing navigation from location A 204 to location B 208 on a presented map. Prior to the navigation starting at the positioning and navigation application executing at phone 202, the user has input location A 204 (which may have been determined by phone 202 as the current location of phone 202 using a geolocation sensor) and location B 208 into the application. As shown in the first interface at the display screen of phone 202, the current location of phone 202 is shown along the route as arrow 206. While the first interface is being presented at phone 202, the user of phone 202 may decide to use at least one other device and desires to transfer the first interface shown at the display screen of phone 202 to each of the other devices. The user can initiate the interface transfer function by using an input mode associated with such a function. Examples of input modes include making a voice command, tapping a button, and/or making a gesture with respect to the first device. After the input mode is activated, the first interface at the first device will present identifying information associated with one or more other available devices to which the current run status of the first interface can be transferred. Specifically in the example of FIG. 2, the user of phone 202 has activated an input mode and as a consequence, both of buttons 220 and 222 appear. Button 220 is associated with transferring the current run status of the first interface to watch 216 (“My Watch”) and button 222 is associated with transferring the current run status of the first interface to vehicle-mounted system 224 (“My Car”). In some embodiments, each of button 220 and button 222 is preconfigured based on device information that was sent by a server to phone 202. For example, in response to the user input to transfer the first interface to another device, phone 202 had sent a request to the server to receive device information associated with available second devices associated with the user of phone 202 to which an application interface can be transferred. In this example, the device information included identifying information associated with watch 216 and also vehicle-mounted system 224 and as such, button 220 and button 222 were respectively generated and presented over the first interface that is displayed at phone 202.

If the user selects “My Watch” button 220 associated with transferring the current run status of the first interface at phone 202 to watch 216, then the user's smart watch is selected as the second device. In response to the selection of “My Watch” button 220, phone 202 is configured to send interface data 218 that includes the current run status of the first interface associated with the positioning and navigation application at phone 202 to watch 216. Then watch 216 is configured to parse received interface data 218 to generate a second interface adapted to the attributes (e.g., display screen dimensions, shape, and resolution) of watch 216. Interface data 218 includes data associated with the current run status of the first interface, which in this example may include, for example, the start location and the end location of the navigation route. The second interface comprises another interface of the same positioning navigation application that was executing at phone 202. The second interface is displayed on the circular display screen of watch 216. As shown at the example display screen of watch 216 in FIG. 2, the second interface of watch 216 shows the same route that was shown at the first interface at phone 202, only that the second interface shows less of the map interface due to the shape and smaller size of the display screen at watch 216 as compared to the display screen of phone 202. For example, the second interface at watch 216 no longer shows the start location and the end location of the navigation route but includes only arrow 226 that is associated with the user's/watch's current location and a portion of the route. Nevertheless, the second interface at watch 216 still shows the user's current location along the same route that was shown in the first interface at phone 202 as arrow 226. In some embodiments, watch 216 is configured to show a walking or bus-riding navigation route between location A to location B based on interface data 218 because watch 216 stores data indicating that the user typically uses (e.g., wears) watch 216 while he or she is walking or riding the bus. For example, the walking or bus-riding navigation route between location A and location B may be different than the car driving navigation route between location A and location B because there may be roads/paths that are available to pedestrians or buses that are not permitted for use by cars. As such, by transferring the current run status of an interface from phone 202 to watch 216 of FIG. 2, it is shown that the second device, watch 216, may directly display navigation information corresponding to the same route that was shown in the first interface at phone 202 without requiring the user to manually open the positioning and navigation application at watch 216 or requiring the user to manually input the start location and end location of the route along which navigation is being performed.

If the user selects “My Car” button 222 associated with transferring the current run status of the first interface at phone 202 to vehicle-mounted system 224, then the user's vehicle-mounted device is selected as the second device. In response to the selection of “My Car” button 222, phone 202 is configured to send interface data 228 that includes the current run status of the first interface associated with the positioning and navigation application at phone 202 to vehicle-mounted system 224. Then vehicle-mounted system 224 is configured to parse received interface data 228 to generate a second interface adapted to the attributes (e.g., display screen dimensions and resolution) of vehicle-mounted system 224. Interface data 228 includes data associated with the current run status of the first interface, which in this example may include, for example, the start location and the end location of the navigation route. The second interface comprises another interface of the same positioning navigation application that was executing at phone 202. The second interface is displayed on the rectangular display screen of vehicle-mounted system 224. As shown at the example display screen of vehicle-mounted system 224 in FIG. 2, the second interface of vehicle-mounted system 224 shows the same route that was shown at the first interface at phone 202, only that the second interface shows more of the map interface due to the larger size of the display screen at vehicle-mounted system 224 as compared to the display screen of phone 202. For example, the second interface at vehicle-mounted system 224 shows the user's current location along the same route that was shown in the first interface at phone 202 as arrow 212 and also the start location of the route as 210 and the end location of the route as 214. In some embodiments, vehicle-mounted system 224 is configured to show a driving navigation route between location A and location B based on interface data 228 because vehicle-mounted system 224 stores data indicating that the user typically uses vehicle-mounted system 224 while he or she is driving or riding in the car to which vehicle-mounted system 224 is attached. As such, by transferring the current run status of an interface from phone 202 to vehicle-mounted system 224 of FIG. 2, it is shown that the second device, vehicle-mounted system 224, may directly display navigation information corresponding to the same route that was shown in the first interface at phone 202 without requiring the user to manually open the positioning and navigation application at vehicle-mounted system 224 or requiring the user to manually input the start location and end location of the route along which navigation is being performed.

As shown in the example of FIG. 2, a first device may send interface data to one or more second devices, where the interface data that is sent to a particular second device is adapted to the attributes associated with that particular (e.g., type of) device. When the interface data associated with a first interface associated with an application is sent to more than one second device, the different second devices may display the same or different second interfaces, depending on the attributes of the second device such as, for example, the display screen size, shape, and resolution, for instance. For example, when interface data including different run status data is sent to each second device, one second device may generate a second interface that is based on the first current run status of the first interface, while another second device may generate a second interface that is based on the second current run status of the first interface. For example, the positioning and navigation application described above may provide navigation data in multiple forms.

As shown in the example of FIG. 2, different devices may differ in how they display the same interface content associated with the same application because of differences in at least the screen sizes and display modes of different devices. For example, the vertical screen on phone 202 displays information such as the determined route and a map surrounding the route. However, watch 216 may only display route information or part of the route because its screen is smaller while vehicle-mounted system 224 horizontally displays information such as the determined route and a map surrounding the route.

Conventional schemes for transferring application interface information typically include transferring historical information between different instances of the same application. For example, the chat records in an instant messaging application or the historical play records in a media player application associated with the same user account may be easily transferred between different devices on which different instances of the same application were executing. Conventionally, when a user switches from using one instance of an application on a device to using another instance of the same application on another device, the user needs to open the second instance of the application at the second device and also manually input information into the second instance of the application at the second device to resume the same state that he or she had left the first instance of the application at the first device. For example, when switching from a first device to a second device, a navigation application needs to be manually input again with navigation information to resume the navigation that was being performed at the first device and a video viewing application needs to be manually searched for content that was playing on the first device. In contrast, in various embodiments described herein, interface data of the first interface of an application that is transferred by the first device includes the context information (e.g., the current run status) of the application at the first device. Thus, the second device can parse the interface data to generate a second interface and directly display the second interface that is determined based on the context information of the first interface. As such, various embodiments described herein enable the transfer of the current context of an application interface and not only the historical records of the application from one device to another. Furthermore, in various embodiments described herein, the user does not need to manually open the instance of the application at the second device or need to manually input context information into the instance of the application at the second device to arrive at the second interface.

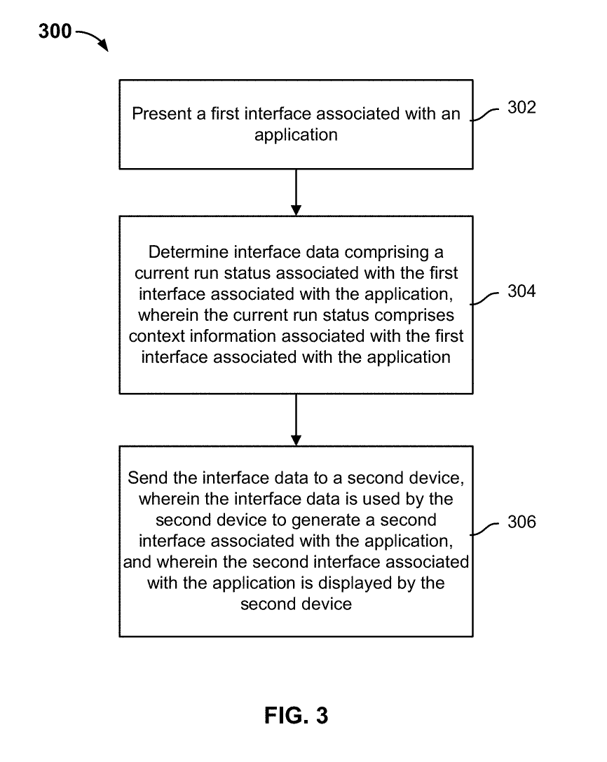

FIG. 3 is a flow diagram showing an embodiment of a process for transferring a current run status of an application interface from one device to another device. In some embodiments, process 300 is performed at the example server of system 100 of FIG. 1.

At 302, a first interface associated with an application is presented at a first device.

At 304, interface data comprising a current run status associated with the first interface associated with the application is determined, wherein the current run status comprises context information associated with the first interface associated with the application.

An application running on a first device may display a first interface. The first interface is a functional display user interface that is provided by the application. The content in the interface is configured according to service features provided by the application and/or user provided information to the application and/or the first device. In a first example, the first interface of a ticket purchasing application may include user interactive elements associated with purchasing tickets for one or more events. In a second example, the first interface of an application downloading application may have application recommendations or introductions of applications.

In various embodiments, the first interface may be transferred from the first device to a second device in response to a user trigger to perform such a transfer through one of multiple possible input modes. After the second device(s) to which the first interface is to be transferred is selected at the first device, the first device determines the interface data to send to the second device(s) based on the current run status of the first interface. In various embodiments, the current run status of the first interface comprises context information of the first interface. In some embodiments, in response to the user trigger to perform the transfer of the first interface to the second device, interface data corresponding to the first interface is obtained. For example, the interface data corresponding to the first interface may be obtained locally from the first device or queried from a remote server (e.g., associated with storing interface data corresponding to one or more interfaces of the application). For example, in response to the user trigger to perform the transfer of the first interface to the second device, the current run status of the first interface is stored at the first device and used to update the obtained interface data.

The interface data then includes the current run status data associated with the first interface associated with the application at the first device. The data that is included in the current run status of the first interface is the context information of the first interface. The context information of the first interface may include user inputs (e.g., user input values, user selections, user made adjustments of settings) that have been received at the first interface. The context information of the first interface may also include a current state of the first device, such as for example, current measurements or readings by sensors that are associated with the first device. Examples of current measurements or readings by sensors that are associated with the first device include a current location of the first device, a current velocity of the first device, a current angle at which the first device is positioned, and a current orientation of the first device. For example, the context information of the first interface includes the content (e.g., input fields or other interactive elements) that is featured on the first interface and/or associated with the service feature(s) that are provided by the application. In a first example, for a first interface of a positioning and navigation application, the current run status may include the first device's current location (e.g., that is obtained from a geolocation sensor of the first device), a user input start location, a user input destination location, and a desired form of transportation (e.g., taking buses, walking, or driving). In a second example, for a first interface of a video playing application, the current run status may include identifying information associated with the video that is being played, the current volume at which the video is played at, and/or the current elapsed time since the start of the video. The interface data is sent to the second device for the second device to generate a second interface to be presented at the second device.

In some embodiments, the obtained interface data corresponding to the first interface includes markup language and/or computer code (e.g., script(s)) to be executed at the first device to store the current run status of the first interface. In some embodiments, the obtained interface data includes language and/or computer code (e.g., script(s)) to be executed at the second device to generate resume status information to be used by the second device to generate the second interface. In some embodiments, the obtained interface data includes various sets of interface descriptive information (which is sometimes referred to as “<layout>” in the markup language of the interface data) and interactive action descriptive information (which is sometimes referred to as “<script>” in the markup language of the interface data) corresponding to different device types. As will be described in further detail below, the second device to which the interface data is sent is configured to determine the set of interface descriptive information and interactive action descriptive information of the interface data that matches the second device's device type (which is sometimes referred to as “<type>” in the markup language of the interface data). For example, the device type may indicate whether the second device is a phone, a watch, a tablet, a vehicle-mounted system, a laptop, or a desktop.

In some embodiments, each set of interactive action descriptive information in the interface data describes the non-interactive content (e.g., text and images) and each set of interactive action descriptive information in the interface data describes interactive elements (e.g., buttons, fields, dynamic elements, or other user interface (UI) controls) that are to be presented in a second interface. In some embodiments, the interface data for the same first interface may describe different non-interactive content and/or the interactive elements to be presented at the second interface depending on the device type (or other attribute) of the second device. In some embodiments, each set of interactive action descriptive information in the interface data describes the non-interactive content (e.g., text and images) and each set of interactive action descriptive information in the interface data describes interactive elements (e.g., buttons, fields, dynamic elements, or other user interface (UI) controls) associated with a particular device type that are configured to be rendered as a second interface that matches the attributes of a second device of that device type. For example, the set of interactive action descriptive information in the interface data describes the non-interactive content (e.g., text and images) and the set of interactive action descriptive information in the interface data describes interactive elements (e.g., buttons, fields, dynamic elements, or other user interface (UI) controls) that correspond to a particular device type can be rendered into a user interface that fits within the dimensions of the display screen, is compatible with the resolution of the display screen, and is compatible with the shape of the display screen.

At 306, the interface data is sent to a second device, wherein the interface data is used by the second device to generate a second interface associated with the application, and wherein the second interface associated with the application is displayed by the second device.

After receiving the interface data, the second device may parse the interface data to obtain UI controls and other interface layout elements of the second interface, and also the current run status information relating to the first interface. Then, the second device can generate the second interface using the UI controls and layout elements from the interface data in a way that the operation of the second interface can resume the service functions of the application from the current run status of the first interface. As a result, the layout/appearance of the second interface associated with the application is adapted to the device type and/or other attributes of the second device but resumes the content that was previously presented at the first interface associated with the application at the first device. For example, if the application were a positioning and navigation application, then the second interface would include at least the start location and the destination location of a route that the user had been in the middle of navigating at the first interface at the first device. In another example, if the application were a social networking application, then the second interface would present posts that the user had been viewing at the first interface as well as any information that the user had been in the middle of inputting at the first interface.

In some embodiments, even after the user triggers for the first interface to be transferred from the first device to a second device, the first interface is continued to be presented at the first device until it is closed.

In summary, while presenting a first interface associated with an application executing at a first device, a user of the first device may trigger one of potentially multiple input modes to cause interface data corresponding to the first interface to be sent from the first device to a selected second device. The interface data includes the current run status data of the first interface. The determined interface data is sent to a second device. After receiving the interface data, the second device parses the interface data and then displays a second interface. This second interface is an interface corresponding to the current run status of the first interface but whose layout is adapted to the second device. The interface is transferred between different devices and can be adapted to each device, without the user having to manually activate/open the application at the second device or having to enter any input information at the second interface at the second device.

In various embodiments, a server service platform is configured to provide device searching and interface transfer capabilities. For example, when a device is connected to the server service platform, it is configured to automatically send its device information to the server. Then, this device information is made available for discovery and searches by other devices at a website or other portal associated with the server service platform. An example of device information that is sent by a device to the server service platform is shown in Table 1, below:

TABLE 1

| Key Field | Identifier | Explanation of Field |
|---|---|---|
| Device identifier | id | Unique device ID, whereby devices find and search for each |
| | | other |
| Device name | name | Device name, whereby devices find and search for each |
| | | other |
| Device type | type | Device type: the type of devices and is used to determine |
| | | how interface data is used at a second device |
| Owner information | owner | Device owner: used for inter-device trust and access |
| | | management |
| Address | ip | The IP address to which the device connects, used for inter- |
| information | | device connections |

For example, User A registers device information for all smart devices that he owns on the server service platform. The device information for User A's smart phone is as follows: device ID:123; device name: smart phone X; device type: phone; owner: A; IP address: 42.120.74.200. The device information for User B's vehicle-mounted device is as follows: device ID:124; device name: vehicle-mounted device Y; device type: car; owner: A; IP address: 42.120.74.210. For example, the server service platform may store for each user, device information for each device that is associated with the user.

Each user may register device information on the server so that the user's devices' information can be queried by the user's devices. In some embodiments, by finding the device information of other devices owned by the same user, a list of available second devices to which an application interface can be transferred can be presented at the first device for a user to select among. The device information associated with the selected second device may then be used to obtain interface data that includes content that matches the device type of the selected second device and/or to send the interface data to the IP address associated with the selected second device. This makes seamless device and application interface transfers from a first device to a second device possible.

In various embodiments, the interface data that is usable to generate a second interface comprises markup language. For example, the markup language can be any language that is able to describe user interfaces (UI) and interactions based on the XML (Extensible Markup Language) format. The markup language used to generate interface data is referred to hereinafter as “markup language,” for illustration. As such, markup language is used to define the interface data and thus usable to accomplish inter-device interface transfer.

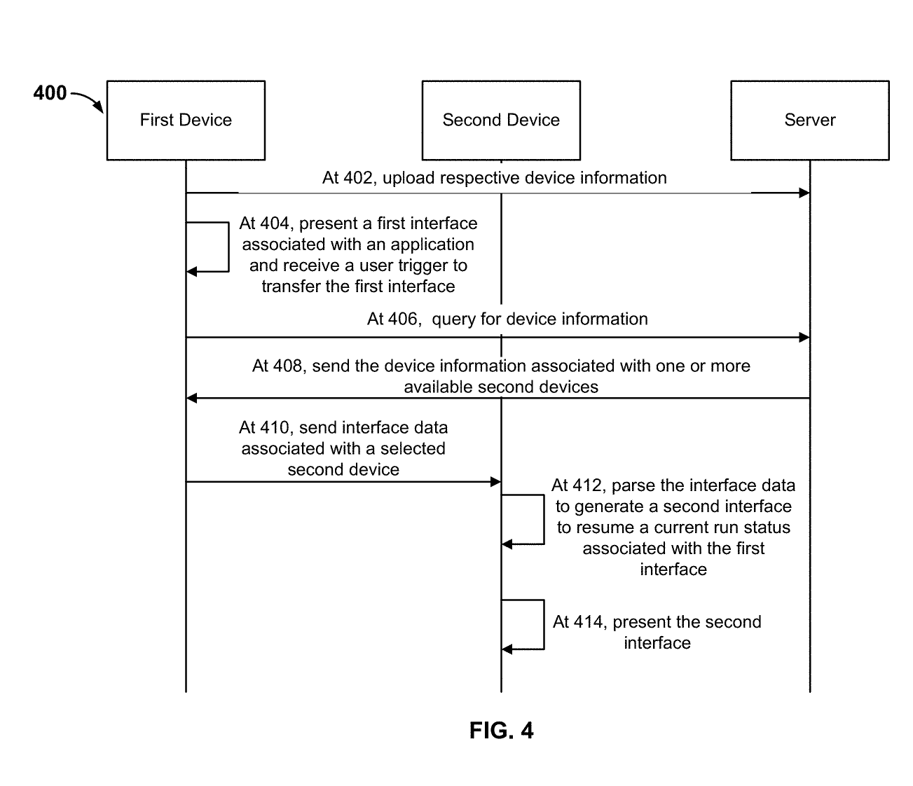

FIG. 4 is a sequence diagram showing an example of transferring a current run status of an application interface from one device to another device. In some embodiments, process 400 is performed at the example server of system 100.

At 402, respective device information is uploaded by a first device and a second device to a server.

In various embodiments, the server may publish writing rules, definitions, and so on for the markup language in advance. Thus, a third party service provider may acquire the markup language from the server, use the markup language definitions, and write interface data for interfaces associated with an application that provides transfer functions. Then, after the third party service provider writes interface data that includes a transfer function, a user may upload the device information of each of his or her devices to the server while using an application that provides a transfer function. The server thus collects device information that it can later send to a requesting user's device so that the requesting device may execute a transfer of an application interface to another device.

The interface data of a first interface that could be requested to be transferred to another device may be defined and written with an interface description language such as markup, for example. In some embodiments, interface data includes: interface descriptive information <layout>, device type information <type>, run status data <data>, and interactive action descriptive information <script>. The interface descriptive information <layout> is configured to describe the appearance, for example, of the second interface. The device type information <type> is configured to describe the device type to which this markup-written interface is to be adapted. The run status data <data> is configured to describe the save and resume logic of the interface context information in the transfer process. The interactive action descriptive information <script> is configured to define the various interactive actions, such as tapping and gesture operations, for example, that are executable by the second interface. <data> includes save logic information <save> and resume logic information <resume>. <save> is for saving the current run status information of the first interface, and <resume> is configured to use the current run status information in the interface data to determine resume status information for the second interface. The execution logic for both <save> and <resume> may be described using JavaScript, for example.

In some embodiments, in the interface data, <type> may describe the device type(s) to which the layout and script in the same interface data can adapt to in the second interface. It may be the same as the device type registered by the device on the server. When an interface has different UI designs and action logics on different device types, the appropriate layout and script may be written separately for each device, and they may be differentiated by type. Therefore, in some embodiments, it is possible to determine the <layout> and <script> required by the second device according to the <type> of the second device. For example, interface data includes corresponding <layout> and <script> descriptions for each different <type>. Then the required UI corresponding to the device type of the second device may be rendered on the second device from <layout>. Moreover, the context information of the transferred first interface is resumed in the second interface according to <data>. The result is a second interface that in appearance is adapted to the second device but includes content that is resumed from the current run status of the first interface as it existed prior to the transfer. It is then possible, on the basis of <script>, to execute interactive actions in response to operations performed on the UI. For example, after tapping the button labeled “call” that is presented at a second interface, a user may access vicinity (e.g., local businesses) information associated with the current location of the second device. In terms of processing the user selection of the “call” button, the interactive action descriptive information <script> portion of the interface data may include JavaScript for calling the corresponding server to execute service operations associated with the selected button.

At 404, a first interface associated with an application is presented at the first device and a user trigger to transfer the first interface is received at the first device.

At 406, the server is queried for device information by the first device based on the user trigger.

At 408, the device information associated with one or more available second devices is sent from the server to the first device.

At 410, a second device is selected at the first device and interface data is sent from the first device to the second device.

When using a first interface associated with an application on a first device, a user may want to transfer the first interface to another of the user's devices. To cause such a transfer, the user may, through voice activation by speaking a keyword or phrase, tapping a button, or some other preset input, trigger the application interface transfer function to start. The user's input is used to represent the user's intention to request transfer of the first interface associated with the application to another device. In a particular implementation, a global gesture with respect to the first device may be a possible preset input. For example, on a smart phone, a possible preset input may be pressing and holding on an interface blank area, while on a vehicle-mounted device, a possible input mode may be a voice activation by speaking a keyword or phrase. When a user requests interface transfer by a preset input, the first device may query the server for device information associated with each device that is associated with the user of the first device. Once the first device receives the device information from the server, the first device will present identifying information (e.g., names) associated with each available device to which the user may send interface data. The user may then select one of such second devices or one of such devices may be preset by the user as a default second device. The first device then saves the first interface's current run status information based on the context displayed by the first interface. For example, the first device may use JavaScript code to execute <save> logic in order to save the first interface's current status information that is to be included in interface data to be sent to the selected second device. For example, in the case of a first interface of a positioning and navigation application, the current location and destination location that are currently shown in the first interface may be saved to a file at the first device. Then, the stored current run status of the first interface is added to stored interface data corresponding to the first interface and the updated interface data is then sent from the first device to the second device. For example, the interface data may be transmitted to the second device via the Internet based on an IP address that is included in the device information that is received from the server.

At 412, the interface data is parsed by the second device to generate a second interface to resume a current run status associated with the first interface.

At 414, the second interface is presented at the second device.

In various embodiments, the second device may obtain a parsing engine (markup engine) in advance from the server. The parsing engine is used to parse an interface written using an interface description language (markup). Thus, the markup engine is an engine that parses markup and calls the operating system GUI framework to generate a UI. Therefore, after the interface data is received, the markup engine may be used to render the service markup as a UI. Moreover, the second interface incorporates the saved current run status associated with the first interface to obtain a second interface that is adapted to the second device.

In some embodiments, the parsing engine includes: a first parsing engine for parsing interface descriptive information, a second parsing engine for mapping UI controls, and a third parsing engine for parsing interactive action descriptive information.

The first parsing engine may also be called a “markup parser.” It is used to parse markup text (i.e., interface descriptive information written in markup language). It can parse XML-based markup text into structured data, which is made available for subsequent generation of UIs and interactive script.

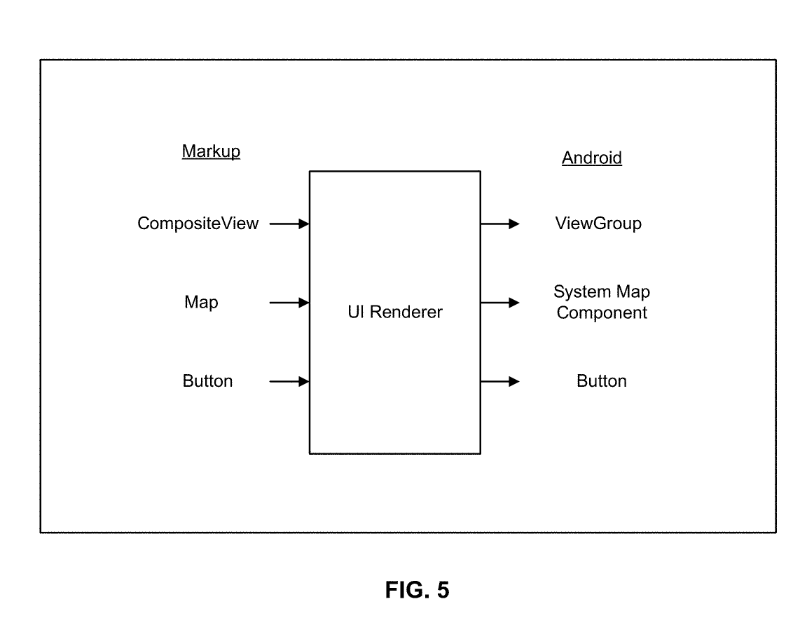

The second parsing engine may also be called a “UI renderer.” It is used to convert UI elements contained in markup <layout> into UI controls in operating systems corresponding to various smart terminals and to generate corresponding UIs (second interfaces) for the terminals. In some embodiments, a corresponding UI renderer is created for each different operating system (e.g., that is used by various mobile platforms). The UI renderer may map each UI element in markup to a UI control on a mobile platform. Thus, it is possible to use UI renderers to generate the needed UIs (second interfaces) on the basis of markup-described UIs for various supported operating systems. Taking an Android® operating system as an example, FIG. 5 is a diagram that shows an example second parsing engine that is used to map UI elements of interface data to the UI in an Android positioning and navigation application interface. As shown in FIG. 5, the markup UI elements CompositeView, Map, and Button are mapped by the UI renderer to the UI controls ViewGroup, system Map component, and Button in an Android system.

Returning to FIG. 4, the third parsing engine may also be called a “script engine.” It is provided to the runtime environment that executes the script data contained in <script>. This runtime environment is composed of V8 and nodes. Using this industry-standard JavaScript runtime environment, the script defined in markup may be executed when rendering a second interface to business logic requirements in the second interface. In one example, the third parsing engine uses JavaScript to implement parsing of and responses to interactive action descriptive information.

In some embodiments, the parsing engine at the second device uses the <type> tag in the interface data to determine the device type of the second device and to acquire the corresponding <layout> and <script> portion of the interface data. After resolving and obtaining UI controls and before displaying the second interface, the parsing engine uses JavaScript code to execute the resume logic of <resume>, using the saved current run status information to resume the current run status that was saved from the first interface.

Due to the script engine, the second interface is configured to provide service features that are provided by the third party service provider associated with the application. It may interactively provide service directly with a server associated with the application. For example, the second interface may present an interactive element that can be selected by a user. In response to the user selection of the interactive element, the second device may send a corresponding operation request to the server based on the content of <script> that is included in the interface data. The response to the operation request that is returned by the server is received at the second device and may be presented at the second interface, if appropriate.

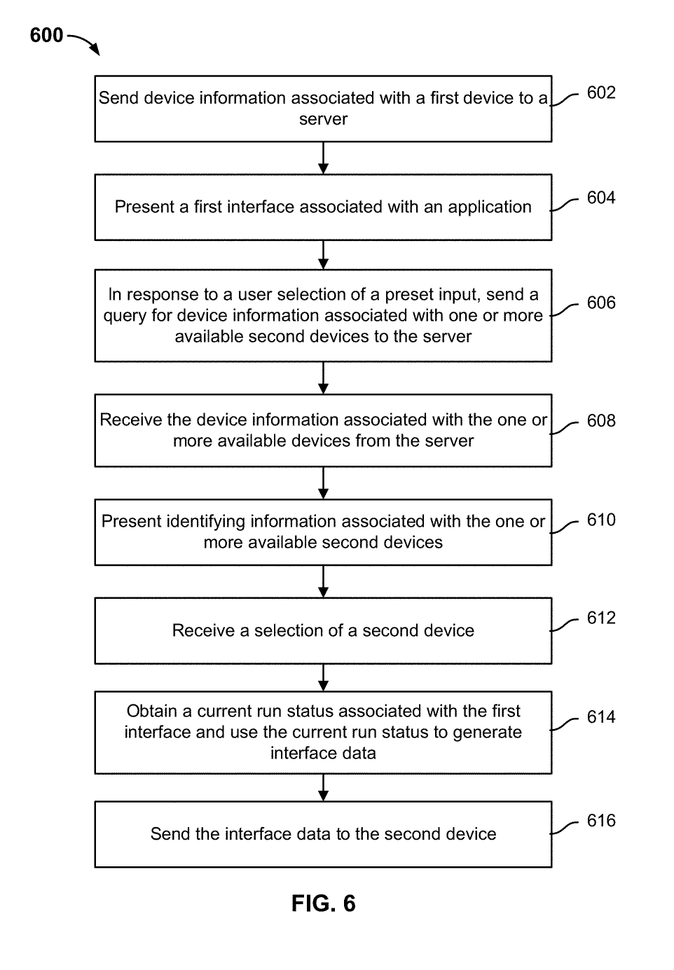

FIG. 6 is a flow diagram showing an embodiment of a process for transferring a current run status of an application interface from a first device. In some embodiments, process 600 is performed at the example first device of system 100 of FIG. 1. In some embodiments, process 600 may be used to implement process 300 of FIG. 3.

At 602, device information associated with a first device is sent to a server.

In some embodiments, a server that supports interface transfer services may publish writing rules, definitions, and so on for the markup language. Thus, a third party service provider may acquire the markup language from the server. A third party service provider (e.g., an application developer) that provides interface transfer services may use markup language definitions and write interface data for one or more application interfaces that is configured to be transferable by the corresponding service.

If the user wishes to use the transfer service between at least two devices that he or she owns, he or she may register device information of at least some of the smart devices that he or she owns to the server. Thus, when the user subsequently desires to transfer an interface from one of his or her devices to another of his or her devices, the transfer may occur on the basis of the device information that the user had previously sent to the server. For example, the device information includes one or more of the following: device identifier, device name, device type, owner information, and IP address information. An example of a set of device information is shown in Table 1, above.

At 604, a first interface associated with an application is presented.

At 606, in response to a user selection of a preset input, a query for device information associated with one or more available second devices is sent to the server.

At 608, the device information associated with the one or more available second devices is received from the server.

At 610, identifying information associated with the one or more available second devices is presented at the first device.

At 612, a selection of a second device is received.

When using a first interface associated with an application on a first device, a user may want to transfer the first interface to another of the user's devices. To cause such a transfer, the user may, through voice activation by speaking a keyword or phrase, tapping a button, or some other preset input, trigger the application interface transfer function to start. The user's input is used to represent the user's intention to request transfer of the first interface associated with the application to another device. In a particular implementation, a global gesture with respect to the first device may be possible in preset input. For example, on a smart phone, a possible preset input may be pressing and holding on an interface blank area, while on a vehicle-mounted device, a possible preset input may be voice activation by speaking a keyword or phrase. When a user requests interface transfer by a preset input, the first device may query the server for device information associated with each device that is associated with the user of the first device. Once the first device receives the device information from the server, the first device will present identifying information (e.g., names) associated with each available device to which the user may send interface data. The user may then select one of such second devices or one such device may be preset by the user as a default second device.

In some embodiments, the server that the first device queries for the device information may include one or more local servers and/or one or more network servers. For example, a local server can be set up locally on a first device and may, for example, be a service process of the first device. A network server may be set up on the network side and may be a service-providing platform. The service platform may consist of one or more servers and be capable of maintaining corresponding business logics and providing business data. It maintains and manages business services. When an interface is to be transferred, a request for device information associated with available second device(s) may be made to the local server to acquire available devices. If the local server is unable to look up such device information, or if the provided second devices are not devices needed by the user, a request may be made to the network server, which then looks up the queried for device information.

The following are example preset inputs that may be selected by a user to initiate a transfer of an application from the first device to a second device:

1) Triggering a control of the first interface. The first interface may provide a control such as a button. This button control may be labeled as performing an interface transfer function. Thus, by tapping the button, the user can trigger the interface transfer, e.g., by tapping the control, to generate a service request for requesting device information from a server and determining the available second devices.

2) Triggering through speech recognition of recorded speech data (e.g., voice activation). The user may also trigger interface transfer through speech recognition. That is, the user may record speech data while the first interface is being displayed. Moreover, the application may recognize this speech data as a command to initiate the application. After the command is recognized, the first device determines that the first interface is to be transferred and then requests for the available second devices for the user to choose from.

3) Triggering by a preset gesture on the first interface. Examples of preset gestures, such as shaking, one or more finger swipes, pressing and holding on an interface blank area, or mid-air gestures, may be used to activate interface transfer services of an application interface from the first device. After a detected gesture input is determined to match to a preset gesture associated with transferring the first interface of the application, the first device determines that the first interface is to be transferred and then requests for the available second devices for the user to choose from.

In some embodiments, if the first device or application has already locally stored device information associated with available second devices, the local server may be used to obtain such device information.

At 614, a current run status associated with the first interface is obtained and used to generate interface data.

The first device determines interface status information based on the current run status of the first interface. For example, if the first interface is processing the current navigation status of the user/first device, the current run status of the first interface may include the current position of the first device, the start location of the route, and a destination location of the route, and so on. In some embodiments, interface data corresponding to one or more interfaces of one or more applications may be obtained (e.g., from a server) and stored at the first device. As such, in response to a user selection to trigger a transfer of a particular first interface of an application, the interface data corresponding to that first interface may be locally obtained at the first device. Then, the first device (e.g., an operating system executing thereon) and/or the application may use JavaScript code to execute <save> logic of the locally obtained interface data in order to save the current run status of the first interface data. The saved current run status of the first interface data is added to the interface data. For example, in the case of a positioning and navigation application interface, the current position of the first device, the start location of the route, and a destination location of the route may be saved to a file. The updated interface data is then sent from the first device to the second device (e.g., based on the IP address associated with the second device as determined in the device information).

In some embodiments, the first interface associated with the application is presented at the first device due to a parsing engine having parsed the interface data. After the user performs an operation (e.g., inputs a value into a field) on the first interface, the first interface's run status may change. Therefore, when the user determines that the first interface needs to be transferred, the status information corresponding to the current run status of the first interface is saved. That is, to obtain the needed interface data to send to the selected second device, the current run status data of the first interface is determined by saving the status information according to the save logic information that is included in the interface data corresponding to the first interface.

In some embodiments, using the current run status data corresponding to the first interface to update the interface data of the first interface at the first device includes: saving the status information of the first interface with the save logic information that is included in the interface data of the first interface; establishing the resume logic information of the status information also based on the save logic information that is included in the interface data of the first interface; and updating the run status data of the interface data according to the save logic information, status information, and resume logic information. That is, JavaScript code is used to execute the <save> logic in <data> to acquire first interface status information (current run status) to be saved and to establish resume logic information <resume> for the status information. Thus, <save>, <resume>, and saved status information are used to update <data>, which is then combined with first interface <type>, <layout>, and <script> to generate interface data to be sent to the second device.

At 616, the interface data is sent to the second device.

The interface data is then sent to the second device. In some embodiments, the interface data may be transmitted to the second device via the Internet based on an IP address associated with the second device that is in the device information.

The second device may display the corresponding second interface based on the received interface data.

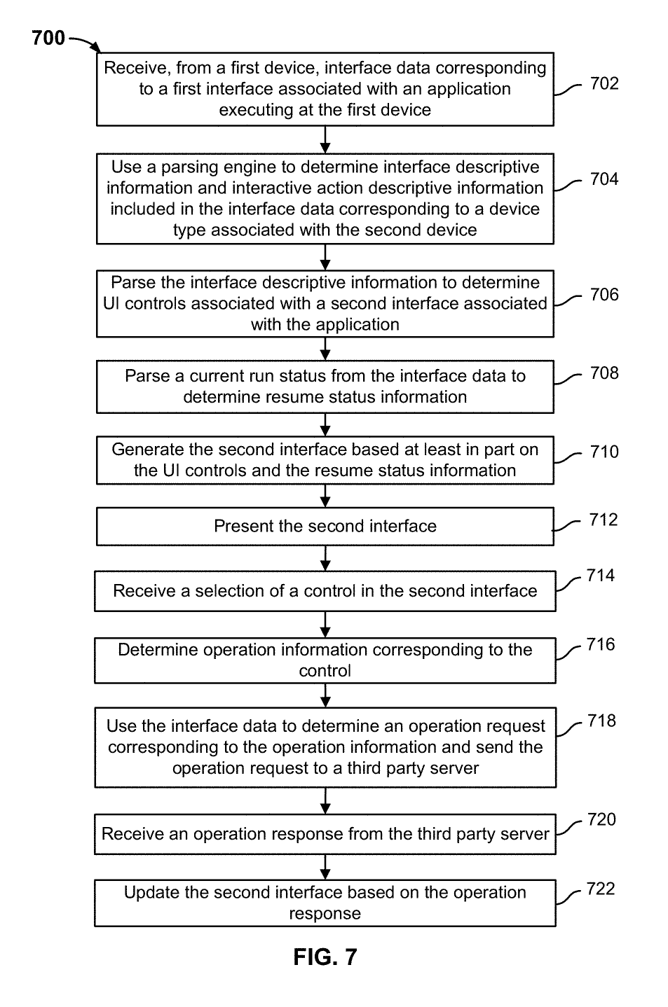

FIG. 7 is a flow diagram showing an embodiment of a process for receiving a transfer of a current run status of an application interface at a second device. In some embodiments, process 700 is performed at the example first device of system 100 of FIG. 1.

At 702, interface data corresponding to a first interface associated with an application executing at a first device is received from the first device.

After a process such as process 600 of FIG. 6 has been executed, the corresponding second device is configured to receive the interface data that is sent from the first device. As described above, the interface data includes the current run status data corresponding to the first interface for resuming the first interface and also interface descriptive information, device type information, and other such information that is associated with the second device.

The interface data is parsed at the second device to generate a second interface, which is adapted to the second device, to resume the first interface's run status at the first device.

At 704, a parsing engine is used to determine interface descriptive information and interactive action descriptive information included in the interface data corresponding to a device type associated with the second device.

A parsing engine is obtained at the second device and/or the application. As mentioned above, the parsing engine is configured to parse the received interface data to generate a second interface and to respond to operation information relating to the second interface. In the process of invoking the parsing engine to parse the interface data, in some embodiments, the device type <type> corresponding to the second device, which may be stored by the second device, for example, is used by the second device to search for portions of the interface data that include interface descriptive information (<layout>) and the interactive action descriptive information (<script>) that match the <type> of the second device. That is, the device type of the second device is used to search in the interface data for interface descriptive information and interactive action descriptive information corresponding to the second device. In some embodiments, the <layout> and/or <script> portions of the interface data that match the <type> of the second device include markup language that is configured to generate content to be presented in a second interface associated with the application that accommodates the attributes of the device type of the second device. For example, attributes of the device type of the second device include the display screen shape of the second device, the display screen dimensions of the second device, and/or the display screen resolution of the second device. If the interface data does not include the interface descriptive information and the interactive action descriptive information that correspond to the device type of the second device, such interface descriptive information and interactive action descriptive information are queried from a server. That is, if the interface data does not have interface descriptive information and interactive action descriptive information corresponding to the device type of the second device, they may be requested from a server.

At 706, the interface descriptive information is parsed to determine UI controls associated with a second interface associated with the application.

At 708, a current run status from the interface data is parsed to determine resume status information.

At 710, the second interface is generated based at least in part on the UI controls and the resume status information.

At 712, the second interface is presented.

A first parsing engine at the second device may be invoked to parse the determined interface descriptive information portion of the interface data. The interface descriptive information is parsed into structured data, e.g., <layout> text written using markup language is parsed into structured data. Then the second parsing engine calls the structured data to determine the UI elements that are to be included in the second interface. The UI elements are mapped to UI controls that are to be included in the second interface. Because different smart terminals may use different operating systems, the applications in the smart terminals are set up according to corresponding operating systems. When the application requests interface data, the required interface data may be acquired on the basis of the associated operating system. The parsing engines of corresponding operating systems may be installed within different apps. Thus, a third parsing engine may convert the determined UI elements into UI controls that specifically correspond to the operating system that is executing at the second device.

The parsing engine at the second device is configured to parse the current run status corresponding to the first interface that is included in the interface data. The current run status is parsed to determine resume status information. The resume status information determines the status information of the second interface. Specifically, in some embodiments, parsing the current run status to determine the resume status information includes to use the resume logic information <resume> in the run status data <data> to determine the resume status information of the second interface based on the current run status. For example, the resume status information includes the information of the current run status and/or includes information that is derived from the current run status. For example, if the application were a positioning and navigation application and the current run status of the first interface included the current location of the user and the start and destination locations of a route being navigated, then the resume status information that is derived from the current run status may include the same start and destination locations of the route being navigated but a current location of the user that is extrapolated further along the route from the current location that had been included in the current run status.

The second interface is then generated according to the determined UI controls and the determined resume status information. That is, the UI controls are combined with the resume status information to generate the second interface that includes a layout of the application content that is adapted to the attributes of the second device but also resumes the run status from that of the first interface that is executing at the first device. For example, in the case of the positioning and navigation application, after the positioning and navigation (second) interface is obtained for display on the second device, the current location of the user and the start and destination locations of a route in the resume status information are already input into the second interface without any user intervention.

At 714, a selection of a control in the second interface is received.

At 716, operation information corresponding to the control is determined.

At 718, the interface data is used to determine an operation request corresponding to the operation information and the operation request is sent to a third party server.

At 720, an operation response is received from the third party server.

At 722, the second interface is updated based on the operation response.

After the second interface is presented at the second device, third party services may be provided to the user through the second interface. The second interface may execute interactive actions in response to user selected operations at the second interface. For example, in response to a user selection of an operation (e.g., a control or other type of interactive element) at the second interface, a response to the selected operation is determined based on the interface data and the response information may be presented within the second interface. If the retrieval and/or the presentation of the response to the selected operation is dictated by the interface data to require communication with a third party server, then the third party server may be queried by the terminal using an operation request.

For example, a control such as a button may be presented in the second interface. Thus, a user may trigger the control by tapping it. The trigger serves as a basis to determine corresponding operation information corresponding to the button. For example, operation information corresponding to the button may include whether and what type of information is to be obtained/processed in response to the selection of the button and also, where the information is to be obtained from and/or where the processing is to be performed. Then interactive actions corresponding to the operation information are executed using interactive action descriptive information that is included in the interface data. For example, interactive action descriptive information that is included in the interface data may dictate that in response to the triggered button, specified types of information are to be sent from the terminal to a third party server in an operation request and that a specified page is to be presented in the second interface as a response to the trigged button.

For example, where the second interface is associated with a ride-hailing application, an operation request for a needed ride-hailing service is generated by the user tapping a button at the second interface. The user may further input the start-point and end-point addresses as request parameters to the operation request for the ride-hailing service. The resulting operation request is sent to a third party server associated with providing the ride-hailing service.

After the third party server receives the operation request, it may execute operation logic corresponding to the operation request and determine the corresponding operation response information. For example, in the case of a ride-hailing request, the third party server associated with supporting the ride-hailing service may issue the ride-hailing task that is maintained by the third party server as the task status and order information subsequent to the order being received as operation response information. In another example, in the case of a food delivery request, the order processing status, delivery status, and so on are maintained by the third party server as operation response information. The third party server can then send the operation response information to the terminal. The received operation response information can be used to update the second interface. For example, updating the second interface with the operation response information includes presenting at least a portion of the operation response information within the second interface.

In a first example application of the techniques described herein, an application may be a movie ticket purchasing application. At a first interface of the movie ticket purchasing application that is executing at a smart phone (the first device), a user may then select a movie theater and a movie for which to purchase a ticket prior to payment for a movie ticket. The user may then select a preset input, at the first interface, to transfer the first interface to a second device. The available second devices, such as a smart watch, a vehicle-mounted device, and a tablet, to which the first interface may be transferred are then displayed on the first interface. After the tablet is selected as the second device to which to transfer the first interface, the context information (current run status) corresponding to the required payment for the selected movie theater and movie is saved at the smart phone to obtain interface data corresponding to the first interface. Then the interface data is sent from the smart phone to the tablet. The tablet uses a markup engine to parse the received interface data. The tablet generates a UI and resumes the saved context information to obtain a second interface that is adapted to the tablet and also presents a user interface of the movie ticket purchasing application that shows that a movie theater and a movie have been selected. The second interface is displayed on the tablet. The user may interact with the second interface to execute payment for a selected screening for the previously selected movie at the previously selected movie theater. The markup engine may call JavaScript code in response to the user operation to execute the payment operation.

In a second example application of the techniques described herein, an application may be a messaging application. At a first interface of the messaging application that is executing at a smart phone (the first device), the user of the smart phone is chatting with another user, Alice. While chatting with Alice, the user may then select a preset input, at the first interface, to transfer the messaging session with the Alice interface to a vehicle-mounted system (a second device). After the vehicle-mounted system is selected as the second device to which to transfer the first interface, the context information (current run status) corresponding to the historical messages between the user of the first device and Alice and also any text/images that have been input by the user of the first device but not yet sent to Alice is saved at the smart phone to obtain interface data corresponding to the first interface. The interface data is then transmitted to the vehicle-mounted device, which uses a markup engine to parse and display the historical messages and not yet sent input text/images by the user of the first device at a messaging interface of the second interface.

Various embodiments described herein enable an application interface to be transferred from one device to another device via sending interface data that describes interface layout and interactions between the devices. As a result, a user can seamlessly switch from using an application on one device to using the same application on another device and have the current state of the interface that was previously used by the user at the first device be preserved and/or resumed at the second device.

As for devices that are not Internet enabled, interface data can be transmitted by transmitting markup data between devices via Bluetooth, NFC, or similar technologies that do not require the Internet.

The modules and sub-modules described above can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

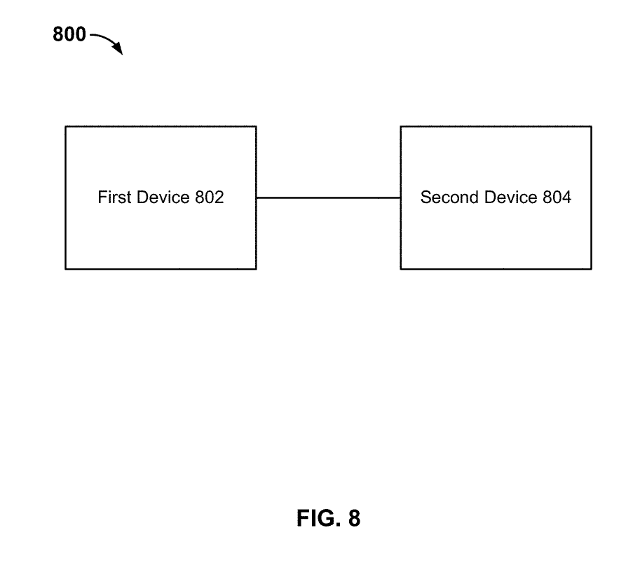

FIG. 8 is a diagram showing an embodiment of a system for transferring a current run status of an application interface between a first device and a second device. System 800 includes first device 802 and second device 804.

First device 802 is configured to determine interface data corresponding to a first interface associated with an application. The first interface is determined to be transferred to a second device in response to a detection of a preset input. First device 802 is configured to send the interface data to second device 804.

Second device 804 is configured to generate and present a second interface associated with an application after parsing the interface data. The second interface resumes the run status of the first interface but is adapted to the attributes of second device 804.

First device 802 is configured to receive a preset input and in response to the preset input, obtain the current run status data for the first interface and use the run status data to generate the interface data.

Second device 804 is configured to resume the first interface's current run status by parsing the interface data and generating a corresponding second interface. In various embodiments, second device 804 receives a parsing engine from a server (not shown). In various embodiments, second device 804 is configured to use the parsing engine to parse the interface data into content that it can use to generate the second interface. Second device 804 is further configured to present the second interface.

In some embodiments, the interface data comprises: interface descriptive information, device type information, and interactive action descriptive information.

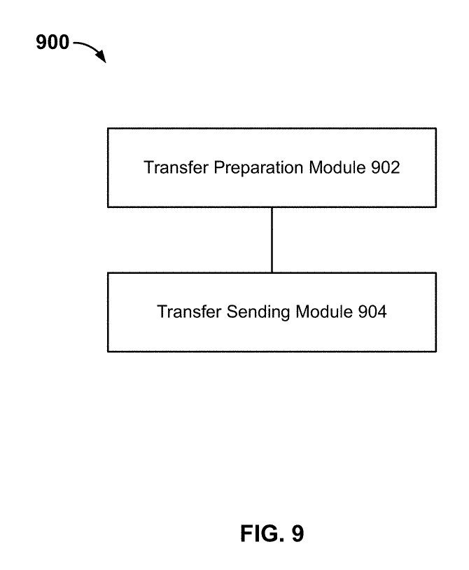

FIG. 9 is a diagram showing an embodiment of a first device for transferring a current run status of an application interface to a second device. System 900 includes transfer preparation module 902 and transfer sending module 904.

Transfer preparation module 902 is configured to determine interface data corresponding to a first interface associated with an application in response to a user selection of a preset input. The interface data comprises the first interface's current run status data.

Transfer sending module 904 is configured to send the interface data to the second device, where the second device is configured to use the interface data to generate and then display a second interface associated with the application.

Transfer preparation module 902 is further configured to request, in response to a preset input, device information associated with at least one available second device from a server and display the available devices. One or more second devices are then selected from the available devices.

Transfer preparation module 902 is further configured to receive preset input and in response, obtain the current run status data for the first interface and to use the current run status data to generate interface data corresponding to the first interface.

Transfer preparation module 902 is further configured to use the first interface's current run status data to update interface data corresponding to the first interface and generate interface data.

In some embodiments, the first interface's current run status data comprises save logic information. Transfer preparation module 902 is further configured to save the status information of the first interface with the save logic information that is included in the interface data of the first interface, establish the resume logic information of the status information based on the save logic information, and generate the resume status information according to the save logic information, status information, and resume logic information.

In some embodiments, system 900 further comprises a registration module for pre-registering device information of the first device on a server.

In some embodiments, the device information includes at least one of the following: device identifier, device name, device type, owner information, and address information. In some embodiments, the interface data further comprises: interface descriptive information, device type information, and interactive action descriptive information.

An embodiment of the present application further provides an inter-device interface transfer means, which is applied to a second device.

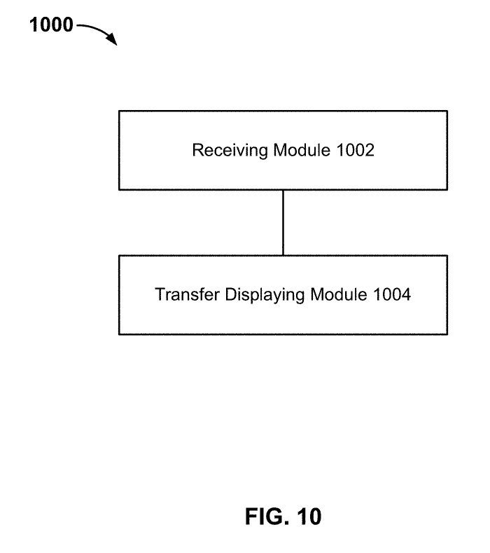

FIG. 10 is a diagram showing an embodiment of a second device for receiving a transfer of a current run status of an application interface from a first device. System 1000 includes receiving module 1002 and transfer displaying module 1004.

Receiving module 1002 is configured to receive, from a first device, interface data corresponding to a first interface associated with an application, where the first interface was displayed at the first device. The interface data comprises at least a current run status corresponding to the first interface.

Transfer displaying module 1004 is configured to display a corresponding second interface after parsing the interface data. The second interface is an interface that resumes the run status of the first interface but that is adapted to the attributes of the second device.

In some embodiments, the interface data further comprises interface descriptive information, device type information, and interactive action descriptive information.

In some embodiments, transfer displaying module 1004 further comprises a parsing and resuming submodule that is configured to resume the first interface's current run status by parsing the interface data and generating a corresponding second interface. In some embodiments, transfer displaying module 1004 further comprises a displaying submodule that is configured to display the second interface.

The parsing and resuming submodule is configured to invoke a parsing engine to parse the interface descriptive information and determine UI controls of the second interface, parse the first interface's current run status data and determine the resume status information of the first interface; and generate the corresponding second interface based on the UI controls and the resume status information.

The parsing and resuming submodule is configured to invoke the parsing engine to parse the interface descriptive information into structured data. Then, UI elements are determined according to the structured data. The UI elements are then matched to UI controls associated with the operating system of the second device.

The parsing and resuming submodule is configured to use resume logic information in the current run status data to determine resume status information for the second interface.

Transfer displaying module 1004 is further configured to use device type information as a basis to determine interface descriptive information and interactive action descriptive information corresponding to the second device from the interface data.

In some embodiments, system 1000 further comprises an interface responding module that is configured to receive operation information relating to the second interface and respond to the operation information based on the interactive action descriptive information that is included in the interface data.

The interface responding module is configured to use the interactive action descriptive information to determine the operation request corresponding to the operation information and to send the operation request to a third party server corresponding to the second interface. Operation response information is received as feedback from the server, and the corresponding content may be presented in the second interface according to the operation response information.

In some embodiments, system 1000 further comprises an engine setup module that is configured to set up a parsing engine in advance. The parsing engine is configured to parse the interface data to generate the second interface and to respond to operation information relating to the second interface.

In some embodiments, the parsing engine comprises a first parsing engine for parsing interface descriptive information, a second parsing engine for mapping UI controls, and a third parsing engine for parsing interactive action descriptive information.

In some embodiments, system 1000 further comprises a device registering module that is configured to pre-register device information of the second device at a server. The device information includes at least one of the following: device identifier, device name, device type, owner information, and IP address information associated with the second device.

The transfer displaying module 1004 is configured to use device type information corresponding to the second device to search for interface descriptive information and interactive action descriptive information corresponding to the second device in the interface data. If the search fails, interface descriptive information and interactive action descriptive information corresponding to the second device are acquired from a server.

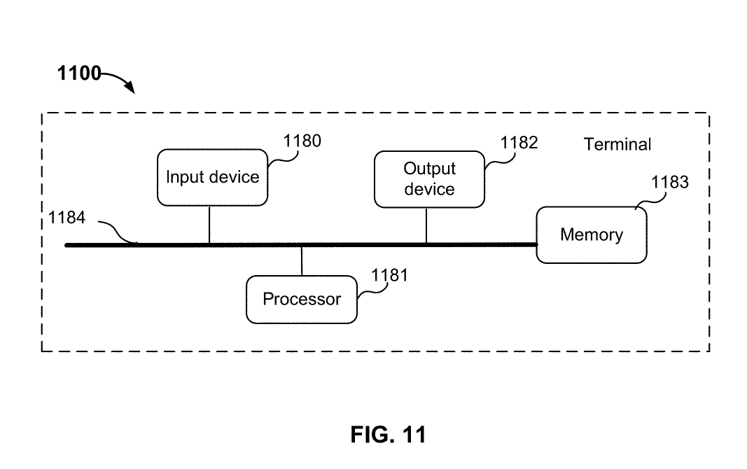

FIG. 11 is a hardware structural diagram of a terminal that is configured to transfer an application interface from a first device to a second device. Terminal 1100 may include input device 1180, processor 1181, output device 1182, memory 1183, and at least one communication bus 1184. Communication bus 1184 is configured to implement inter-component communication connections. Memory 1183 may contain high-speed RAM memory. It may also contain non-volatile memory (NVM), such as at least one magnetic disk storage device. Memory 1183 may store various programs used to complete various processing functions and to implement the method steps of the present embodiment.

Optionally, processor 1181 could be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. Processor 1181 is coupled to the aforementioned input device 1180 and output device 1182 through a wired or wireless connection.

Optionally, input device 1180 may comprise multiple input devices. For example, it could comprise at least one of the following: a user-oriented user interface, a device-oriented device interface, a software programmable interface, a camera, and a sensor. Optionally, the device-oriented device interface may be a wired interface for conducting device-to-device data transmissions, or it could be a hardware insertion interface (e.g., a USB interface or a serial port) for conducting device-to-device data transmissions. Optionally, the user-oriented user interface could, for example, be user-oriented control keys, a speech input device for receiving voice input, or a touchscreen perceiving device (such as a touchscreen or a touch tablet having touch-sensing functions). Optionally, the programmable interface of the software described above could be a portal, such as a chip input pin interface or output interface, through which the user edits or modifies the program. Optionally, the transceiver described above could be a radio-frequency transceiver chip, a baseband chip, or a transceiver antenna. A microphone or other audio input device can receive voice data. Output device 1182 may include a display device, sound equipment, and other output devices.

In the present embodiment, the processor of the computing device comprises functions for executing all modules in the data-processing means in each device. For specific functions and technical results, refer to the embodiments described above. They will not be discussed further here.

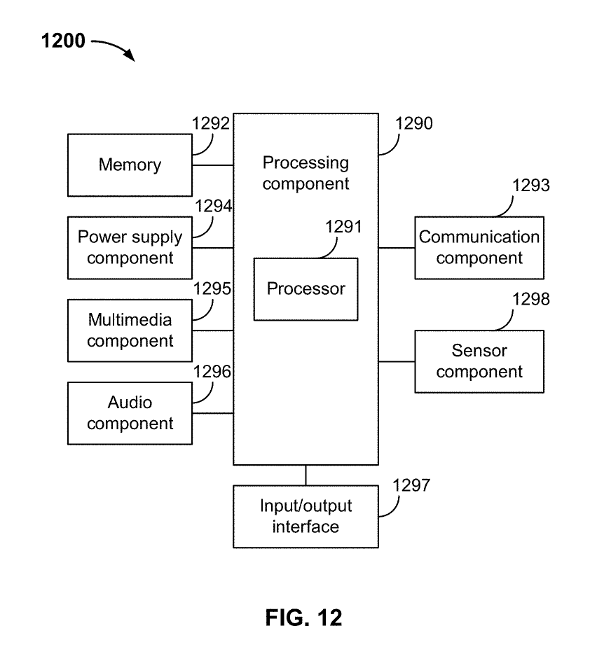

FIG. 12 is a hardware structural diagram of a terminal device provided by another embodiment of the present application. FIG. 12 is a specific embodiment in the implementation process relating to FIG. 11. As shown in FIG. 12, the terminal device 1200 of the present embodiment comprises a processor 1291 and memory 1292.

The processor 1291 executes the computer code stored in the memory 1292 and thus implements the data-processing methods of FIGS. 3, 4, 6, and 7 and in the embodiments described above.

The memory 1292 is configured to store all kinds of data in support of terminal device operations. Examples of this data include any application or method instructions, such as messages, pictures, and video, used for operations on the terminal device. The memory 1292 may contain random access memory (RAM) and may also contain non-volatile memory, such as at least one magnetic disk storage device.

Optionally, the processor 1291 is set up in a processing component 1290. The terminal device may further comprise: a communication component 1293, a power supply component 1294, a multimedia component 1295, an audio component 1296, an input/output interface 1297, and/or a sensor component 1298. The components specifically contained within the terminal device are set according to need. The present embodiment imposes no limitations with regard to them.

The processing component 1290 generally controls the overall operations of the terminal device. The processing component 1290 can comprise one or more processors 1291 for executing instructions so as to complete all or some of the steps of the method described above with regard to FIGS. 3, 4, 6, and 7. In addition, the processing component 1290 may comprise one or more modules to facilitate interaction between the processing component 1290 and other components. For example, the processing component 1290 may comprise a multimedia module to facilitate interaction between the multimedia component 1295 and the processing component 1290.

The power supply component 1294 provides electric power to the various components of the terminal device. The power supply 1294 can include a power supply management system, one or more power supplies, and other components related to generating, managing, and allocating power to the terminal device.

The multimedia component 1295 comprises an output interface display screen provided between the terminal device and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touches, sliding actions, and gestures on the touch panel. The touch sensor can not only detect the boundaries of touch or slide actions, but also can measure duration and pressure related to the touch or slide operations.

The audio component 1296 is configured to output and/or input audio signals. For example, the audio component 1296 includes a microphone (MIC). When the terminal device is in an operating mode, e.g., speech/voice recognition mode, the microphone is configured to receive external audio signals. The received audio signals can be further stored in the storage device 1292 or sent by the communication component 1293. In some embodiments, the audio component 1296 further comprises a speaker for output of audio signals.

The input/output interface 1297 provides an interface between the processing component 1290 and peripheral interface modules. The aforesaid peripheral interface modules may be keyboards, click wheels, buttons, etc. These buttons may include but are not limited to: volume button, start button, and lock button.

The sensor component 1298 comprises one or more sensors and is used to provide status evaluations of various aspects of the terminal device. For example, the sensor component 1298 may detect the on/off status of the terminal device, the relative position of the component, and the presence or absence of contact between the user and the terminal device. The sensor component 1298 may comprise a near sensor that is configured to detect the presence of a nearby object when there is no physical contact, including measurements of distance between the user and the terminal device. In some embodiments, the sensor component 1298 may further comprise a camera.

The communication component 1293 is configured to facilitate wired or wireless communication between the terminal device and other devices. The terminal device may access wireless networks based on a communications standard such as WiFi, 2G, 3G, or combinations thereof. In an embodiment, the terminal device may comprise a SIM card slot. The SIM card slot is for inserting a SIM card, which enables the terminal device to register with a GPRS network and establish communication between the Internet and servers.

It is clear from the above that the communication component 1293, audio component 1296, input/output interface 1297, and sensor component 1298 that relate to the FIG. 12 embodiment may serve as an implementation of the input device in the FIG. 11 embodiment.

In a terminal device of the present embodiment, the processor, while displaying a first interface, determines to-be-transmitted interface data corresponding to the first interface based on a preset input, the interface data comprising run status data. The communication component, coupled to the processor, sends the to-be-transmitted interface data to the second device.

In another terminal device, the communication component, coupled to the processor, receives interface data corresponding to a first interface, wherein the interface data comprises run status data. The processor, after parsing the interface data, displays a corresponding second interface, wherein the second interface is an interface corresponding to the first interface and adapted to the second device.

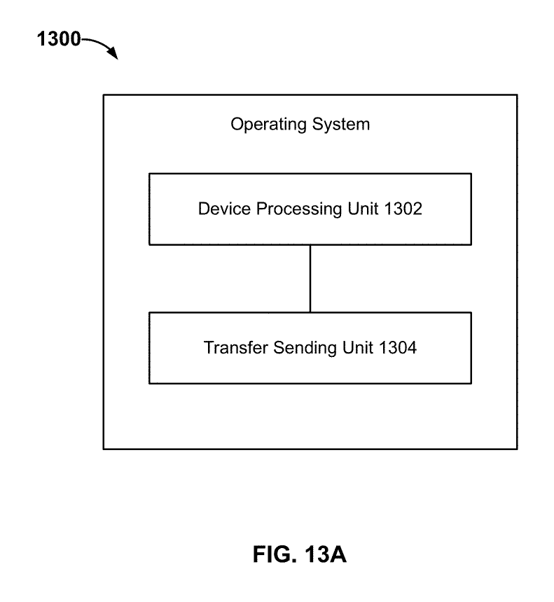

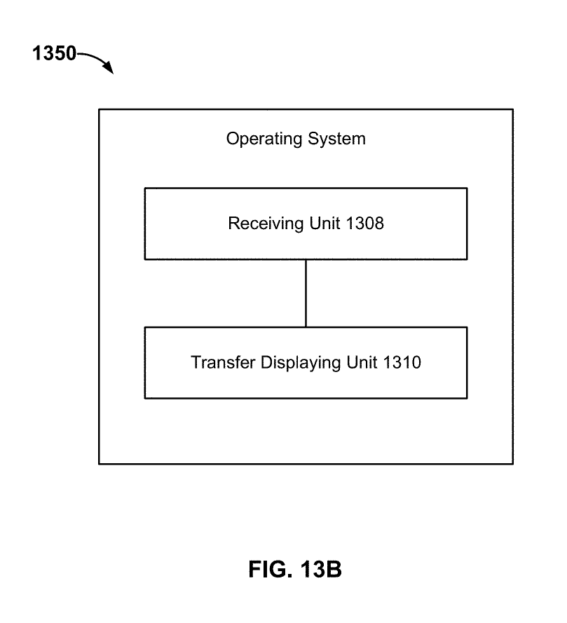

FIG. 13A is a diagram showing an embodiment of an operating system of a first device. Operating system 1300 comprises device processing unit 1302 and transfer sending unit 1304.

Device processing unit 1302 is configured to determine interface data corresponding to a first interface associated with an application, where the first interface is to be sent from a first device to a second device. The interface data comprises the current run status data of the first interface.

Transfer sending unit 1304 is configured to send the interface data to the second device. The second device is configured to generate a second interface based on the interface data and to display the second interface at the second device.

FIG. 13B is a diagram showing an embodiment of an operating system of a second device. Operating system 1350 comprises receiving unit 1308 and transfer displaying unit 1310.

Receiving unit 1308 is configured to receive, from a first device, interface data corresponding to a first interface associated with an application executing at the first device. The interface data comprises the current run status data of the first interface.

Transfer displaying unit 1310 is configured to display a corresponding second interface after parsing the interface data. The second interface is an interface corresponding to the first interface but is adapted to the attributes of the second device.

Each of the embodiments contained in this description is described in a progressive manner. The explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, an embodiment of the present application may take the form of one or more computer program products implemented on computer-usable storage media (including but not limited to magnetic disk memory, CD-ROM, and optical memory) containing computer-usable program code.

In one typical configuration, the computer equipment comprises one or more processors (CPUs), input/output interfaces, network interfaces, and memory. Memory may include such forms as volatile memory in computer-readable media, random access memory (RAM) and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read only memory (CD-ROM), digital versatile disk (DVD) or other optical storage, cassette tapes, magnetic tape and disk storage or other magnetic storage devices, or any other non-transmitting media that may be used to store computer-accessible information. In accordance with the definitions in this document, computer-readable media does not include transitory computer-readable media (transitory media) such as modulated data signals and carrier waves.

The embodiments of the present application are described with reference to flowcharts and/or block diagrams based on methods, terminal devices (systems), and computer program products of the embodiments of the present application. Please note that each process flow and/or block within the flowcharts and/or block diagrams and combinations of process flows and/or blocks within the flowcharts and/or block diagrams can be implemented by computer instructions. These computer program commands can be provided to the processors of general-purpose computers, specialized computers, embedded processor devices, or other programmable data-processing terminals to produce a machine. The commands executed by the processors of the computers or other programmable data-processing terminal devices consequently give rise to means for implementing the functions specified in one or more processes in the flowcharts and/or one or more blocks in the block diagrams.

These computer program commands can also be stored in computer-readable memory that can guide the computers or other programmable data-processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal devices and made to execute a series of steps on the computers or other programmable data-processing terminal devices so as to give rise to computer-implemented processing. The commands executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise the elements.

Detailed introductions were provided above to a multiple service-integrating method, a multiple service-integrating system, a multiple service-integrating means, a smart terminal, a server, and a context-based service operating system provided by the present application. This document has applied specific examples to explain the principles and implementations of the present application. The above descriptions of the embodiments are only for the purpose of aiding the understanding of the methods and core concepts of the present application. A person with ordinary skill in the art will always be able to make modifications in keeping with the idea of the present application to specific embodiments and scopes of the application. The content of this specification should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A first device, comprising:
a processor configured to:
present a first interface associated with an application;
determine interface data comprising a current run status associated with the first interface associated with the application, wherein the current run status comprises context information associated with the first interface associated with the application; and
send the interface data to a second device, wherein the interface data is used by the second device to generate a second interface associated with the application, and wherein the second interface associated with the application is displayed by the second device; and
a memory coupled to the processor and configured to provide the processor with instructions.

2. The first device of claim 1, wherein the processor is configured to receive an input associated with initiating a transfer of the first interface.

3. The first device of claim 1, wherein the processor is configured to:
receive an input associated with initiating a transfer of the first interface;
in response to the input, send a query to a server for device information associated with one or more available second devices;
receive the device information associated with the one or more available second devices;
present identifying information associated with the one or more available second devices; and
receive a user selection of the second device.

4. The first device of claim 3, wherein the input comprises one or more of the following:
speaking a word or phrase, tapping an interactive element, or performing a gesture.

5. The first device of claim 3, wherein to send the interface data to the second device comprises to:
determine an IP address associated with the second device from the device information associated with the one or more available second devices; and
send the interface data to the IP address associated with the second device.

6. The first device of claim 1, wherein to determine the interface data comprising the current run status associated with the first interface associated with the application comprises to:
obtain the interface data;
use a portion of the interface data to store one or more pieces of data associated with the current run status associated with the first interface associated with the application; and
update the interface data with the one or more pieces of data associated with the current run status.

7. A method, comprising:
presenting, at a first device, a first interface associated with an application;
determining interface data comprising a current run status associated with the first interface associated with the application, wherein the current run status comprises context information associated with the first interface associated with the application; and
sending the interface data to a second device, wherein the interface data is used by the second device to generate a second interface associated with the application, and wherein the second interface associated with the application is displayed by the second device.

8. The method of claim 7, further comprising receiving an input associated with initiating a transfer of the first interface.

9. The method of claim 7, further comprising:
receiving an input associated with initiating a transfer of the first interface;
in response to the input, sending a query to a server for device information associated with one or more available second devices;
receiving the device information associated with the one or more available second devices;
presenting identifying information associated with the one or more available second devices; and
receiving a user selection of the second device.

10. The method of claim 9, wherein the input comprises one or more of the following:
voice activation, tapping an interactive element, or performing a gesture.

11. The method of claim 9, wherein sending the interface data to the second device comprises:
determining an IP address associated with the second device from the device information associated with the one or more available second devices; and
sending the interface data to the IP address associated with the second device.

12. The method of claim 7, wherein determining the interface data comprising the current run status associated with the first interface associated with the application comprises:
obtaining the interface data;
using a portion of the interface data to store one or more pieces of data associated with the current run status associated with the first interface associated with the application; and
updating the interface data with the one or more pieces of data associated with the current run status.

13. A recipient device, comprising:
a processor configured to:
receive, from a sender device, interface data corresponding to a first interface associated with an application executing at the sender device, wherein the interface data comprises a current run status associated with the first interface, wherein the current run status comprises context information associated with the first interface associated with the application;
parse the interface data to generate a second interface associated with the application that is determined based at least in part on the current run status associated with the first interface associated with the application; and
present the second interface associated with the application; and
a memory coupled to the processor and configured to provide the processor with instructions.

14. The recipient device of claim 13, wherein to parse the interface data comprises to use a device type associated with the recipient device to determine corresponding interface descriptive information and interactive action descriptive information included in the interface data.

15. The recipient device of claim 14, wherein the processor is further configured to:
parse the interface descriptive information to determine user interface (UI) controls associated with the second interface associated with the application;
parse the current run status to determine resume status information; and
generate the second interface associated with the application based at least in part on the UI controls and the resume status information.

16. The recipient device of claim 15, wherein to parse the interface descriptive information to determine UI controls comprises to:
determine UI elements from the interface descriptive information; and
map the UI elements to the UI controls associated with an operating system associated with the recipient device.

17. The recipient device of claim 13, wherein the processor is further configured to:
receive a selection of an interactive element in the second interface;
use the interface data to determine an operation request corresponding to the interactive element;
send the operation request to a server;
receive an operation response from the server; and
update the second interface based at least in part on the operation response.

18. A method, comprising:
receiving, from a sender device, interface data corresponding to a first interface associated with an application executing at the sender device, wherein the interface data comprises a current run status associated with the first interface;
parsing the interface data to generate a second interface associated with the application that is determined based at least in part on the current run status associated with the first interface associated with the application; and
presenting the second interface associated with the application.

19. The method of claim 18, wherein parsing the interface data comprises using a device type associated with a recipient device to determine corresponding interface descriptive information and interactive action descriptive information included in the interface data.

20. The method of claim 19, further comprising:
parsing the interface descriptive information to determine user interface (UI) controls associated with the second interface associated with the application;
parsing the current run status to determine resume status information; and
generating the second interface associated with the application based at least in part on the UI controls and the resume status information.
